(19) United States
(12) Patent Application Publication
(10) Pub. No.: US 2024/0396941 A1
(43) Pub. Date: Nov. 28, 2024

(54) HIERARCHICAL POLICY ASSESSMENT AND ENFORCEMENT

(71) Applicant: INTERNATIONAL BUSINESS MACHINES CORPORATION, Armonk, NY (US)

(72) Inventors: Anca Sailer, Scarsdale, NY (US); Vikas Agarwal, Noida (IN); Karen Frida Yorav, Haifa (IL); Malgorzata Steinder, Leonia, NJ (US); Louis Ralph Degenaro, White Plains, NY (US)

(21) Appl. No.: 18/321,214

(22) Filed: May 22, 2023

(51) Int. Cl. H04L 9/40

(52) U.S. Cl. CPC H04L 63/20; H04L 63/105

(57) ABSTRACT

Provided are techniques for hierarchical policy assessment and enforcement. A Policy Validation Point (PVP)/orchestrator of a plurality of PVP/orchestrators is in a policy assessor hierarchy, where the plurality of PVP/orchestrators are located at multiple, different levels, and where a first PVP/orchestrator of the plurality of PVP/orchestrators at a higher-level of the policy assessor hierarchy has more granular controls than a second PVP/orchestrator of the plurality of PVP/orchestrators at a lower-level of the policy assessor hierarchy. The PVP/orchestrator receives a policy, determines a compliance granularity of the policy to be sent to a component of a particular lower-level of the policy assessor hierarchy, converts the policy based on the determined compliance granularity into a format understood by the component at the particular lower-level, where the component returns a result indicating whether the policy was enforced by a service, converts the result to a standard format, and returns the converted result.

### BACKGROUND

Embodiments of the invention relate to a hierarchical policy assessment and enforcement. In particular, certain embodiments of the invention relate to hierarchical policy assessment tools orchestration.

A policy assessment tool may be described as a tool that manages and enforces the policy with respect to hardware, software, a service, etc. For example, for a service that stores data, the policy may indicate that data is to be encrypted, and the policy assessment tool enforces this policy.

Existing policy assessment tools and orchestration centers may be fragmented. For example, different policy assessment tools typically work at different levels, with some being higher-level policy assessment tools having knowledge of both controls (such as security and privacy controls published by the National Institute of Standards and Technology (NIST) 800-53, AC-1) and rules (such as a rule for password length: password_length_should_be_min_#chars) and with other tools being lower-level policy assessment tools working with system specific checks (e.g., code to check whether the minimum password length is set as per the rule or not). In addition, there may be requirements from the policy assessment tools when users do not need them.

### SUMMARY

In accordance with certain embodiments, a computer-implemented method comprising operations is provided for hierarchical policy assessment and enforcement. In such embodiments, a Policy Validation Point (PVP)/orchestrator of a plurality of PVP/orchestrators is in a policy assessor hierarchy, where the plurality of PVP/orchestrators are located at multiple, different levels, and where a first PVP/orchestrator of the plurality of PVP/orchestrators at a higher-level of the policy assessor hierarchy has more granular controls than a second PVP/orchestrator of the plurality of PVP/orchestrators at a lower-level of the policy assessor hierarchy. The PVP/orchestrator receives a policy, determines a compliance granularity of the policy to be sent to a component of a particular lower-level of the policy assessor hierarchy, converts the policy based on the determined compliance granularity into a format understood by the component at the particular lower-level, wherein the component returns a result indicating whether the policy was enforced by a service, converts the result to a standard format, and returns the converted result.

In accordance with other embodiments, a computer program product comprising a computer readable storage medium having program code embodied therewith is provided, where the program code is executable by at least one processor to perform operations for hierarchical policy assessment and enforcement. In such embodiments, a Policy Validation Point (PVP)/orchestrator of a plurality of PVP/orchestrators is in a policy assessor hierarchy, where the plurality of PVP/orchestrators are located at multiple, different levels, and where a first PVP/orchestrator of the plurality of PVP/orchestrators at a higher-level of the policy assessor hierarchy has more granular controls than a second PVP/orchestrator of the plurality of PVP/orchestrators at a lower-level of the policy assessor hierarchy. The PVP/orchestrator receives a policy, determines a compliance granularity of the policy to be sent to a component of a particular lower-level of the policy assessor hierarchy, converts the policy based on the determined compliance granularity into a format understood by the component at the particular lower-level, wherein the component returns a result indicating whether the policy was enforced by a service, converts the result to a standard format, and returns the converted result.

In accordance with yet other embodiments, a computer system comprises one or more processors, one or more computer-readable memories and one or more computer-readable, tangible storage devices; and program instructions, stored on at least one of the one or more computer-readable, tangible storage devices for execution by at least one of the one or more processors via at least one of the one or more memories, to perform operations for hierarchical policy assessment and enforcement. In such embodiments, a Policy Validation Point (PVP)/orchestrator of a plurality of PVP/orchestrators is in a policy assessor hierarchy, where the plurality of PVP/orchestrators are located at multiple, different levels, and where a first PVP/orchestrator of the plurality of PVP/orchestrators at a higher-level of the policy assessor hierarchy has more granular controls than a second PVP/orchestrator of the plurality of PVP/orchestrators at a lower-level of the policy assessor hierarchy. The PVP/orchestrator receives a policy, determines a compliance granularity of the policy to be sent to a component of a particular lower-level of the policy assessor hierarchy, converts the policy based on the determined compliance granularity into a format understood by the component at the particular lower-level, wherein the component returns a result indicating whether the policy was enforced by a service, converts the result to a standard format, and returns the converted result.

### BRIEF DESCRIPTION OF THE SEVERAL VIEWS OF THE DRAWINGS

Referring now to the drawings in which like reference numbers represent corresponding parts throughout:

FIG. 1 illustrates a computing environment in accordance with certain embodiments.

FIG. 2 illustrates a computing environment with components of a policy assessor hierarchy in accordance with certain embodiments.

FIG. 3 illustrates a policy assessor hierarchy in accordance with certain embodiments.

FIG. 4 illustrates, in a flowchart, operations by a Governance, Risk, and Compliance (GRC) system in accordance with certain embodiments.

FIG. 5 illustrates, in a flowchart, operations by a Policy Validation Point (PVP)/orchestrator in accordance with certain embodiments.

FIG. 6 illustrates, in a flowchart, operations for hierarchical policy assessment and enforcement in accordance with certain embodiments.

### DETAILED DESCRIPTION

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

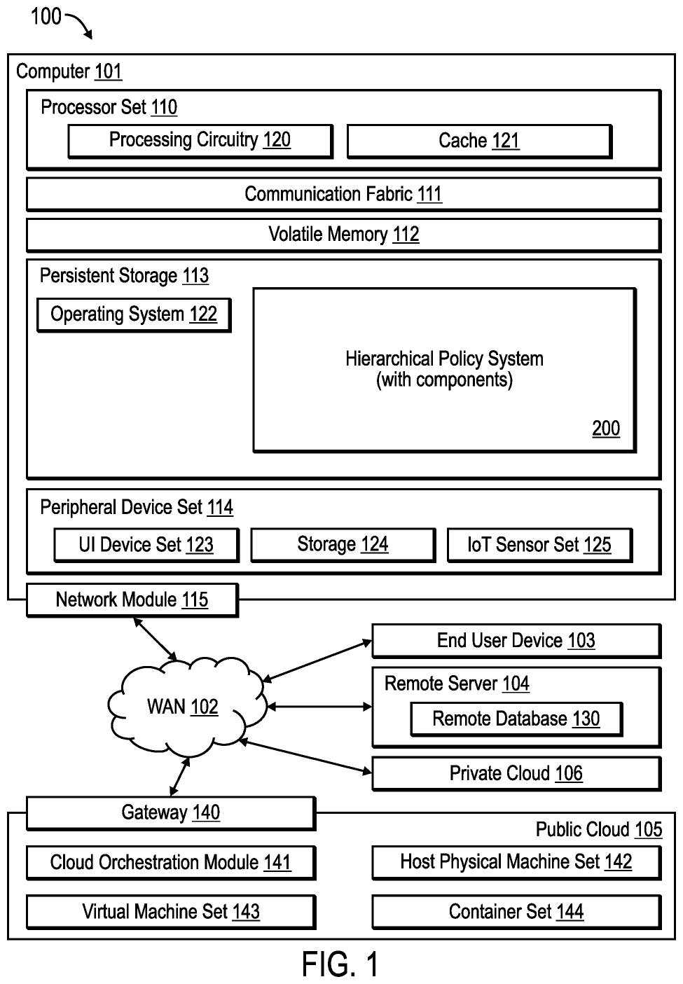

FIG. 1 illustrates a computing environment 100 in accordance with certain embodiments. Computing environment 100 contains an example of an environment for the execution of at least some of the computer code involved in performing the inventive methods, such as a hierarchical policy system 200 with components. In certain embodiments, here are several components of the hierarchical policy system 200, and the components may be on a same computer 101 or the components may be on different computers 101. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

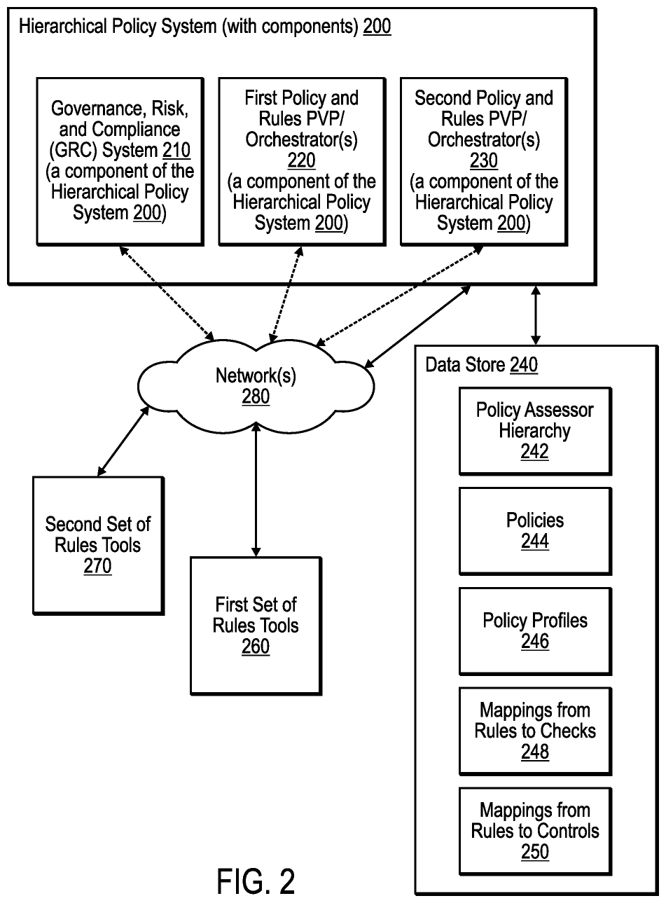

FIG. 2 illustrates a computing environment with components of a policy assessor hierarchy in accordance with certain embodiments

The hierarchical policy system 200 includes a Governance, Risk, and Compliance (GRC) system 210, one or more first policy and rules Policy Validation Point (PVP)/orchestrators 220, and one or more second policy and rules PVP/orchestrators 230. In certain embodiments, the components 210, 220, 230 each implement a portion of the hierarchical policy system 200. In certain embodiments, the hierarchical policy system 200, including the components 210, 220, 230, is implemented at one computer that has the architecture of computer 101 and is connected to the one or more networks 280. In certain other embodiments, each of the components 210, 220, 230 is implemented at separate computers that each have the architecture of computer 101 and are each connected to the one or more networks as illustrated by the dashed lines.

In FIG. 2, the hierarchical policy system 200 is also connected to a data store 240. The data store 240 includes a policy assessor hierarchy (describing which components are at each level of the hierarchy) 242, policies 244, policy profiles 246, mappings from rules to checks 248, and mappings from rules to controls 250. In certain embodiments, there may be mappings from controls to rules to checks stored together (e.g., in a document, a database, a file etc.). There may be different mappings from rules to checks 248 and mappings from rules to controls 250 for each inventory item (e.g., each service, software, Virtual Machine (VM), etc.). An inventory item may be part of a target system. In certain embodiments, given a rule, the mappings from rules to checks 248 may be used to identify one or more checks, and, given a check, the mappings from rules to checks 248 may be used to identify one or more rules. In certain embodiments, given a rule, the mappings from rules to controls 250 may be used to identify one or more controls, and, given a control, the mappings from rules to controls 250 may be used to identify one or more rules.

In addition, the (GRC) system 210, the one or more first policy and rules PVP/orchestrators 220, the one or more second policy and rules PVP/orchestrators 230, the data store 240, a first set of rules tool 260, and the second set of rules tools 270 are connected to one or more networks 280. The one or more networks 280 may be any combination of: the Internet, a Wide Area Network (WAN), a Local Area Network (LAN), an internal bus (for communication between any components at one computer), etc.

A PVP tool may be described as an assessment tool that executes the checks corresponding to various policy rules to determine whether the target system (e.g., an information system, one or more components working together, etc.) adheres to those rules or not. An orchestrator may be described as a component that orchestrates the compliance assessment tasks and compliance data flow across a variety of PVPs and combines their assessment results in a consistent way. The term “PVP/orchestrator” indicates that a particular component may act as a PVP, as an orchestrator or as both a PVP and an orchestrator.

The PVP/orchestrators 220, 230 and the rules tools 260, 270 may be referred to as components of a policy assessor hierarchy.

The first set of rules tools 260 may be described as a first set of policy assessment tools, and the second set of rules tools 270 may be described as a second set of policy assessment tools. In various embodiments, the tools in the first set of rules tools 260 and the second set of rules tools 270 may be different tools or may have some common tools.

With embodiments, the hierarchical policy system 200 provides a way to transform and propagate high-level regulatory/customer policies to lower-level tools (e.g., policy assessment tools) in the hierarchy, while sending the assessment results from low-level policy higher up in the hierarchy. In certain embodiments, the hierarchical policy system 200 converts from standard policies to tool specific policies going down in the hierarchy. With embodiments, the hierarchical policy system 200 provides conversion and aggregation of results from tool-specific formats to standard formats (e.g., generic formats) going up in the hierarchy.

With embodiments, one or more of the PVP/orchestrators 220, 230 in the policy assessor hierarchy work both as an orchestrator aggregating assessment results from lower-level policy assessment tools (such as rules tools 260, 270) and as a PVP sending those results to higher-level orchestrators.

The PVP/orchestrators 220, 230 may be organized in a hierarchical way with higher-level PVP/orchestrators having more granular compliance controls than lower-level PVP/orchestrators. In addition, some of the PVP/orchestrators 220, 230 in middle layers of the policy assessor hierarchy act both as an orchestrator (for PVPs below to aggregate results from those) and as a PVP for the orchestrator in the upper layer (to provide the aggregated results).

At each level of the policy assessor hierarchy, the PVP/orchestrator 220, 230 at that level decides what compliance granularity should be used. This assessment is performed for controls of different regulations (“regulatory controls”), and the Graphical User Interface (GUI) (“dashboard”) provides information on aggregations per regulation. Moreover, embodiments provide regulation agnostic controls and rules. These are service specific rules that are checked by the set of rules tools 260, 270 (acting as PVPs). This may be done more for operational compliance than regulatory compliance.

In addition, there may be a policy profile associated with a user, with a group of users, etc. The policy profile includes services (such as services and/or software used in a user's environment), and the services are associated with controls, and the corresponding set of one or more rules that the service is to comply with the controls. Examples of controls include policy and procedure controls, account management controls, access enforcement controls, information flow controls, etc. These policy profiles are aligned and consumed downwards in the policy assessor hierarchy, while results go up in the policy assessor hierarchy. Also, each Plan of Action and Milestones (POAM) flows downwards in the policy assessor hierarchy. A POAM may be described as a document that identifies risks associated with the target system and tracks remediation activities on behalf of the target system owner.

In certain embodiments, there may be requirements from the rules tools 260, 270 when users at that level in the policy assessor hierarchy do not need them, such as: mappings of rules to controls, GRC aggregations (e.g., aggregations of results at controls level), and audit reporting versus operational reporting. In certain embodiments, audit reporting happens in term of controls of a regulation, whereas operational reporting happens in term of rules status for a given inventory item (e.g., a service, software, a VM, etc.). In certain embodiments, lower-level rules tools 260, 270 are more system specific (i.e., specific to the target system) and work with specific formats such as Security Content Automation Protocol (SCAP™), Yet Another Markup Language (YAML), etc. (SCAP is a trademark of the National Institute of Standards and Technology (NIST) in the United States and/or other countries.) Moreover, higher-level PVP/orchestrators 220, 230 may be generic and work with standardized formats (e.g., Open Security Controls Assessment Language (OSCAL)) or are able to convert low-level formats to standard formats.

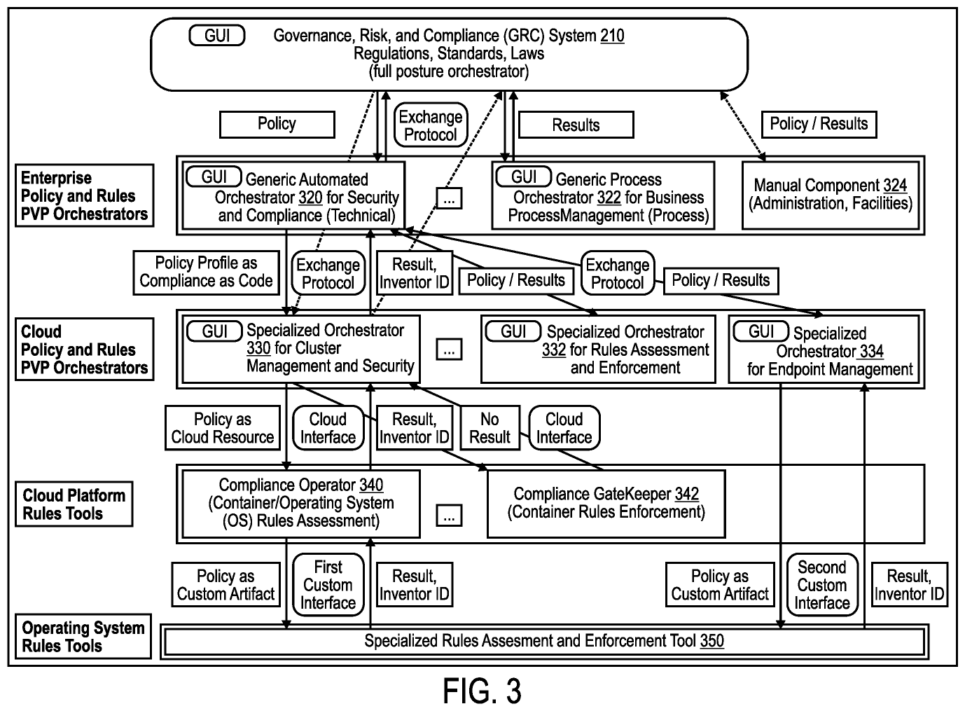

FIG. 3 illustrates a policy assessor hierarchy in accordance with certain embodiments. At a first level of the policy assessor hierarchy, a GRC system 210 includes a GUI, and a user may use the GUI to identify policies (i.e., particular regulations, standards, and/or laws) to be pushed to lower-level tools, which then enforce those policies.

At a second level of the policy assessor hierarchy, there are enterprise policy and rules PVP/orchestrators, which are an example of the one or more first policy and rules PVP/orchestrators 220. In certain embodiments, the enterprise policy and rules PVP/orchestrators include a generic automated orchestrator 320 for security and compliance (e.g., where technical refers to rules that may be checked automatically via software), a generic process orchestrator 322 for business process management (where process refers to any procedure), and a manual component 324 for administration and physical facilities. The generic automated orchestrator 320 includes a GUI, and a user may use the GUI to configure the services mapping from controls to rules, services in a user account, what policy is to be applied to a user account/environment, etc. The generic process orchestrator 322 includes a GUI, and a user may use the GUI for configuration of the business process orchestrator. The manual component 324 is used for checking of controls that are not automated, such as whether physical security is used to restrict access to the target system, etc.

At a third level of the policy assessor hierarchy, there are cloud policy and rules PVP/orchestrators, which are an example of the one or more second policy and rules PVP/orchestrators 230. In certain embodiments, the cloud policy and rules PVP/orchestrators include a specialized orchestrator 330 for cluster management and security, a specialized orchestrator 332 for rules assessment and enforcement, and a specialized orchestrator 334 for endpoint management. Each orchestrator 330, 332, 334 includes a GUI to enable users to configure the respective components with mappings from controls to rules to checks and other configuration information.

At a fourth level of the policy assessor hierarchy, there are cloud platform rules tools, which are an example of the first set of rules tools 260. The cloud platform rules tools include a compliance operator 330 and a compliance gatekeeper 342. The compliance operator 330 performs container and Operating System (OS) rules assessment. The compliance gatekeeper 342 performs container rules enforcement.

At a fifth level of the policy assessor hierarchy, there are operating system rules tools, which are an example of the second set of rules tools 270. The operating system rules tools include a specialized rules Assessment and enforcement tool 350.

In certain embodiments, the components at the first level, the second level, and the third level of the policy assessor hierarchy communicate with each other using an exchange protocol. In certain embodiments, the exchange protocol is OSCAL-based.

In certain embodiments, the GRC system 210 sends a policy, using an exchange protocol, to the enterprise policy and rules PVP/orchestrators: the generic automated orchestrator 320, the generic process orchestrator 322, and/or the manual component 324, and the enterprise policy and rules PVP/orchestrators may return a result using the exchange protocol. In certain embodiments, the GRC system 210 and the orchestrators 320, 322 on the second level of the policy assessor hierarchy interact using the exchange protocol, while the GRC system 210 and the manual component 324 do not communicate using the exchange protocol. The dashed line from the GRC system 210 to the third level orchestrator 330 indicates that the GRC system 210 does not have to go via the generic orchestrators 320, 322 on the second level to interact with the orchestrator 330 on the third level, but that the GRC system 210 may directly interact with the third level orchestrator 330 without using a second level generic orchestrator 320, 322. Thus, the GRC system 210 may also send the policy to the cloud policy and rules PVP/orchestrators: the specialized orchestrator 330, the specialized orchestrator 332, and the specialized orchestrator 334,, and the cloud policy and rules PVP/orchestrators may return a result using the exchange protocol.

The generic automated orchestrator 320 converts the policy to a policy profile (e.g., compliance as code representation) and sends, using the exchange protocol, the policy profile to the specialized orchestrator 330. Compliance as code refers to representation of the compliance information in a machine readable format, such as OSCAL, and the generic orchestrator 320, 322 maps regulation controls to specific rules applicable to various components/services in a user's environment and also obtains the parameter values for these rules, creates data (e.g., a policy profile). The specialized orchestrator 330 coverts the policy profile (in compliance as code format) to a policy as cloud resource (i.e., a “cloud policy”) and sends, using the cloud interface the policy as cloud resource to the compliance operator 340 and the compliance gatekeeper 342. The compliance operator 340 converts the policy as cloud resource to a policy as custom artifact (i.e., “tool policy” or checks) and sends, using the first custom interface, the policy as custom artifact to the specialized rules assessment and enforcement tool 350. The first custom interface is specific to a service. The specialized rules assessment and enforcement tool 350 validates and/or enforces the policy as custom artifact on the existing service (which is executing) and returns, using the first custom interface, a result (e.g., pass, fail or partial pass with reference to the policy being checked) and inventory item (e.g., a specific instance of a service, an instance of software, an instance of a VM, etc.) to the compliance operator 340. The compliance operator 340 returns, using the cloud interface, the result and inventory item identifier (ID) (“inventory ID”) to the specialized orchestrator 330. The specialized orchestrator 330 returns, using the exchange protocol, the result and a description of the inventory item to the generic automated orchestrator 320. The compliance gatekeeper 342 does not return results to the specialized orchestrator 330.

In addition, the generic automated orchestrator 320 converts a higher-level policy (such as a policy based on regulatory controls) to a specific policy (such as a lower-level policy based on rules) and sends, using the exchange protocol, the specific policy to the specialized orchestrator 332, and returns results to the GRC system 210. Moreover, the generic automated orchestrator 320 converts the higher-level policy (such as a higher-level policy based on regulatory controls) to a specific policy and sends, using the exchange protocol, the specific policy to the specialized orchestrator 334. The specialized orchestrator 334 converts the specific policy to a policy as custom artifact and sends, using the second custom interface, the policy as custom artifact to the specialized rules assessment and enforcement tool 350. The second custom interface is specific to a service and allows the specialized orchestrator 334 to directly interact with the specialized rules assessment and enforcement tool 350. The specialized rules assessment and enforcement tool 350 enforces the policy as custom artifact and returns, using the second custom interface, a result and inventory item ID to the specialized orchestrator 334. The specialized orchestrator 334 converts the result and inventory item ID to a higher-level result and returns, using the exchange protocol, the higher-level result to the generic automated orchestrator 320. The generic automated orchestrator 320 aggregates the results from the specialized orchestrators 330, 332, 334 and returns, using the exchange protocol, the results to the GRC system 210. The GRC system 210 aggregates the results from the generic automated orchestrator 320, the generic process orchestrator 322, and the manual component 324.

In certain embodiments, a top level regulatory policy may be described in terms of regulation controls. Then, each inventory item (e.g., software, service, VM, etc.) implements each of these controls through one or more technology specific rules. For example, a VM may have two rules such as, the minimum password length is a certain number of characters (min_pass_length_#chars) and a maximum password expiration (max_pass_expiry) that maps to a control. Similarly, the VM may have other rules mapping to other controls. Likewise, each inventory item (e.g., software, service, VM, etc.) also defines the mappings of rules to controls.

For each rule, (for various types of inventory) a PVP defines corresponding checks that validate whether the rules pass or fail. So, a PVP may define a check (check the password length (check_pass_length) for the rule min_pass_length and others.

Depending on the level of the PVP/orchestrator, a policy may be defined either in terms of controls or rules or checks.

A PVP gets a policy at the rules or checks level (i.e., which checks to perform) and sends the results of these checks for each inventory item (e.g., instances of services, software, VMs, etc.) to the higher-level orchestrator. The higher-level orchestrator uses the mapping from rules to checks 248 to compute the pass/fail for each of the rules and also uses the mapping from rules to controls 250 to aggregate rules for a specific control to compute the status for a control. These control level statuses are then also aggregated across different inventory items in a user's environment to create a control status across the user's environment. The status for the controls (in a policy) provides the compliance status of that policy (i.e., which controls are satisfied and which are not).

In FIG. 3, the PVP/orchestrators may provide both levels of compliance views, such as regulatory controls or operational rules for security and compliance. The PVP/orchestrators perform the job of mapping regulation agnostic rules to regulatory controls. These middle level orchestrators act as the bridge between purely rule based orchestrators and regulatory control-based orchestrators. The orchestrators receive compliance statuses against rules from underlying PVPs and/or orchestrators and map them to regulatory controls to generate results of regulatory control status and pass these results to higher-level orchestrators.

Each exchange interaction between an orchestrator and a PVP is either based on rules or controls. Hence, the policy profile to be passed downwards comprises either rules or controls.

The OSCAL based exchange protocol may be used for top level orchestrators that integrate a wide variety of PVPs, whereas lower-level orchestrators may use custom interfaces as they are more technology specific and support specific types of PVPs.

Thus, embodiments provide a hierarchical PVP/orchestrator architecture with multiple levels of orchestrators and/or PVPs and with a specific exchange protocol provided at each level for ease of integration.

Embodiments enable integration of different PVPs and orchestrators in one common design. Embodiments provide flexibility to use specific policy and result formats at different levels. Embodiments also enable translation from higher-level policy (e.g., OSCAL based profile/assessment plans) to lower-level policy by mapping controls to rules and mapping rules to checks.

In certain embodiments, the hierarchical policy system 200 organizes the PVP/orchestrators in a hierarchical structure, where there are multiple levels of orchestrators and PVPs, and a specific exchange protocol at each level. The hierarchical policy system 200 enables integration of different PVPs and orchestrators in one design, where top level orchestrators have more granular compliance controls than the next level, and some of the PVPs in the middle layers act as both orchestrator for those below (to aggregate results from those below), and act as PVPs for the orchestrators above (to provide aggregated results). The hierarchical policy system 200 determines at each level what compliance granularity is needed, supporting translation from high level policy (regulatory controls, integrating a wide variety of PVPs, etc.) to lower-level policy (operational compliance, technology specific, supporting specific types of PVPs, etc.).

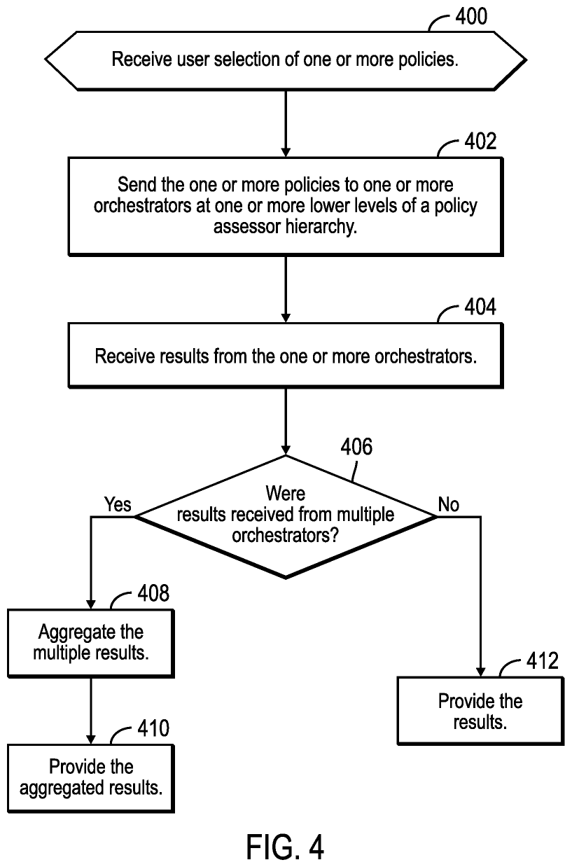

FIG. 4 illustrates, in a flowchart, operations by a Governance, Risk, and Compliance (GRC) system 200 in accordance with certain embodiments. Control begins at block 400 with the GRC system 210 receiving user selection of one or more policies. In block 402, the GRC system 210 sends the one or more policies to one or more orchestrators at one or more lower-levels of a policy assessor hierarchy. In block 404, the GRC system 210 receives results from the one or more orchestrators. In block 406, the GRC system 210 determines whether results were received from multiple orchestrators. If so, processing continues to block 408, otherwise, processing continues to block 412.

In block 408, the GRC system 210 aggregates the multiple results. In block 410, the GRC system 210 provides the aggregated results (e.g., by displaying the results via the GUI). In block 412, the GRC system 210 provides the results (e.g., by displaying the results via the GUI).

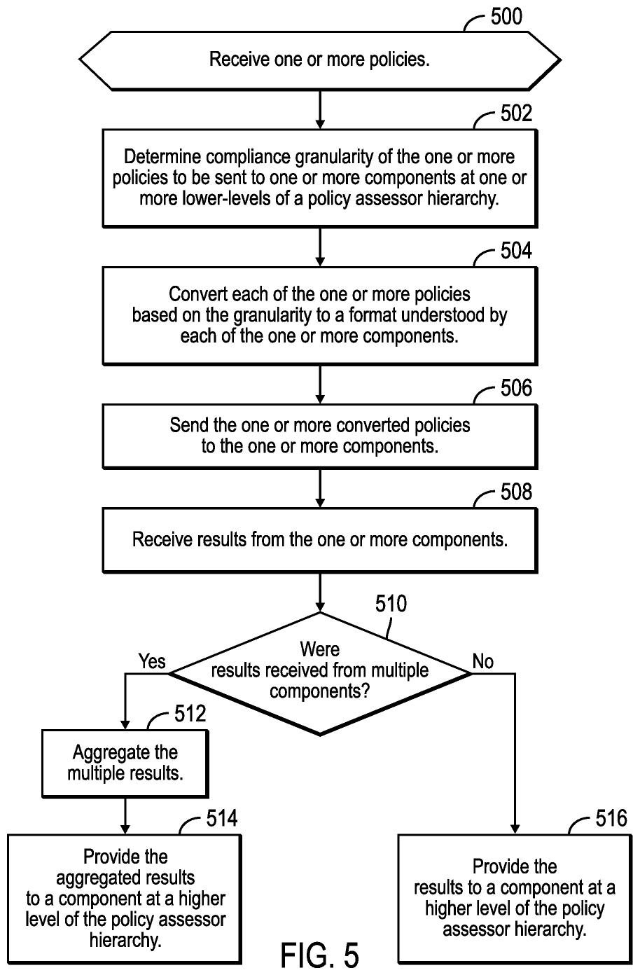

FIG. 5 illustrates, in a flowchart, operations by a PVP/orchestrator 220, 230 in accordance with certain embodiments. Control begins at block 500 with the PVP/orchestrator 220,230 receiving one or more policies. In block 502, the PVP/orchestrator 220, 230 determines compliance granularity of the one or more policies to be sent to one or more components at one or more lower-levels of a policy assessor hierarchy. In block 504, the PVP/orchestrator 220, 230 converts each of the one or more policies based on the granularity to a format understood by each of the one or more components. In block 506, the PVP/orchestrator 220, 230 sends the one or more converted policies to the one or more components. In block 508, the PVP/orchestrator 220, 230 receives results from the one or more components.

In block 510, the PVP/orchestrator 220, 230 determines whether results were received from multiple components. If so, processing continues to block 512, otherwise, processing continues to block 516.

In block 512, the PVP/orchestrator 220, 230 aggregates the multiple results. In block 514, the PVP/orchestrator 220, 230 provides the aggregated results to a component at a higher-level of the policy assessor hierarchy. In block 516, the PVP/orchestrator 220, 230 provides the results to a higher-level component. The higher-level component may be the GRC system 210 or may be another PVP/orchestrator 220, 230.

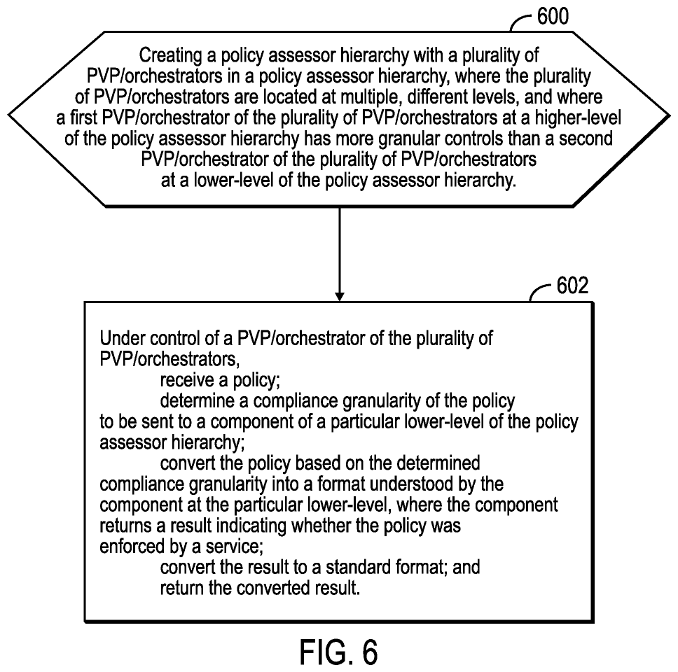

FIG. 6 illustrates, in a flowchart, operations for hierarchical policy assessment and enforcement in accordance with certain embodiments. Control begins at block 600 with creation of a policy assessor hierarchy with a plurality of PVP/orchestrators in a policy assessor hierarchy, where the plurality of PVP/orchestrators are located at multiple, different levels, and where a first PVP/orchestrator of the plurality of PVP/orchestrators at a higher-level of the policy assessor hierarchy has more granular controls (e.g., compliance controls) than a second PVP/orchestrator of the plurality of PVP/orchestrators at a lower-level of the policy assessor hierarchy. In certain embodiments, creating the policy assessor hierarchy may include receiving instructions on which components are at which level of the policy assessor hierarchy and storing a description of the policy assessor hierarchy so that each component at each level of the hierarchy may access the description.

In block 602, a PVP/orchestrator of the plurality of PVP/orchestrators performs: receiving a policy; determining a compliance granularity of the policy to be sent to a component of a particular lower-level of the policy assessor hierarchy; converting the policy based on the determined compliance granularity into a format understood by the component at the particular lower-level, where the component returns a result indicating whether the policy was enforced by a service; converting the result to a generic format; and returning the converted result.

In certain embodiments, a specific exchange protocol is provided for communication between components at adjacent levels of the policy assessor hierarchy.

In certain embodiments, the PVP/orchestrator receives multiple results from one or more other PVPs/orchestrators at lower-levels of the policy assessor hierarchy, aggregates the multiple results, and returns the aggregated results.

In certain embodiments, in response to the component being another PVP/orchestrator, the policy is converted into a policy profile, while, in response to the component being a cloud tool, the policy is converted into a cloud policy.

In certain embodiments, the conversion from higher-levels of the policy assessor hierarchy to lower-levels of the policy assessor hierarchy converts controls of the policy to rules using a mapping of rules to controls, and the rules may be converted to checks using a mapping of rules to checks.

With embodiments, the PVP/orchestrator may act as both a PVP and as an orchestrator.

In certain embodiments, the hierarchical policy system 200 is suitable for audit automation. Thus, the hierarchical policy system 200 obviates the need for humans to distribute controls (policies) manually, obviates the need for humans to collect and store evidences (results) manually, provides instant compliance status via continuous distribution and collection, provides multi-cloud aggregate compliance status via standardized exchange protocol, and facilitates automated audit-ready computing systems for pre-configured compliance standards.

The terms “an embodiment”, “embodiment”, “embodiments”, “the embodiment”, “the embodiments”, “one or more embodiments”, “some embodiments”, and “one embodiment” mean “one or more (but not all) embodiments of the present invention(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise.

The terms “a”, “an” and “the” mean “one or more”, unless expressly specified otherwise.

In the described embodiment, variables a, b, c, i, n, m, p, r, etc., when used with different elements may denote a same or different instance of that element.

Devices that are in communication with each other need not be in continuous communication with each other, unless expressly specified otherwise. In addition, devices that are in communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the present invention need not include the device itself.

The foregoing description of various embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto. The above specification, examples and data provide a complete description of the manufacture and use of the composition of the invention. Since many embodiments of the invention can be made without departing from the spirit and scope of the invention, embodiments of the invention reside in the claims herein after appended. The foregoing description provides examples of embodiments of the invention, and variations and substitutions may be made in other embodiments.

What is claimed is:

1. A computer-implemented method, comprising operations for:
under control of a Policy Validation Point (PVP)/orchestrator of a plurality of PVP/orchestrators in a policy assessor hierarchy, wherein the plurality of PVP/orchestrators are located at multiple, different levels, and wherein a first PVP/orchestrator of the plurality of PVP/orchestrators at a higher-level of the policy assessor hierarchy has more granular controls than a second PVP/orchestrator of the plurality of PVP/orchestrators at a lower-level of the policy assessor hierarchy,
receiving a policy;
determining a compliance granularity of the policy to be sent to a component of a particular lower-level of the policy assessor hierarchy;
converting the policy based on the determined compliance granularity into a format understood by the component at the particular lower-level, wherein the component returns a result indicating whether the policy was enforced by a service;
converting the result to a standard format; and
returning the converted result.

2. The computer-implemented method of claim 1, wherein a specific exchange protocol is provided for communication between components at adjacent levels of the policy assessor hierarchy.

3. The computer-implemented method of claim 1, wherein the operations further comprise:
under the control of the PVP/orchestrator,
receiving multiple results from one or more other PVPs/orchestrators at lower-levels of the policy assessor hierarchy;
aggregating the multiple results; and
returning the aggregated results.

4. The computer-implemented method of claim 1, wherein the operations further comprise:
in response to the component being another PVP/orchestrator, converting the policy into a policy profile; and
in response to the component being a cloud tool, converting the policy into a cloud policy.

5. The computer-implemented method of claim 1, wherein the conversion from higher-levels of the policy assessor hierarchy to lower-levels of the policy assessor hierarchy converts controls of the policy to rules using a mapping of rules to controls.

6. The computer-implemented method of claim 5, wherein the rules are converted to checks using a mapping of rules to checks.

7. The computer-implemented method of claim 1, wherein the PVP/orchestrator acts as both a PVP and as an orchestrator.

8. A computer program product, the computer program product comprising a computer readable storage medium having program instructions embodied therewith, the program instructions executable by a processor to cause the processor to perform operations for:
under control of a Policy Validation Point (PVP)/orchestrator of a plurality of PVP/orchestrators in a policy assessor hierarchy, wherein the plurality of PVP/orchestrators are located at multiple, different levels, and wherein a first PVP/orchestrator of the plurality of PVP/orchestrators at a higher-level of the policy assessor hierarchy has more granular controls than a second PVP/orchestrator of the plurality of PVP/orchestrators at a lower-level of the policy assessor hierarchy,
receiving a policy;
determining a compliance granularity of the policy to be sent to a component of a particular lower-level of the policy assessor hierarchy;
converting the policy based on the determined compliance granularity into a format understood by the component at the particular lower-level, wherein the component returns a result indicating whether the policy was enforced by a service;
converting the result to a standard format; and
returning the converted result.

9. The computer program product of claim 8, wherein a specific exchange protocol is provided for communication between components at adjacent levels of the policy assessor hierarchy.

10. The computer program product of claim 8, wherein the program instructions are executable by the processor to cause the processor to perform further operations for:
under the control of the PVP/orchestrator,
receiving multiple results from one or more other PVPs/orchestrators at lower-levels of the policy assessor hierarchy;
aggregating the multiple results; and
returning the aggregated results.

11. The computer program product of claim 8, wherein the program instructions are executable by the processor to cause the processor to perform further operations for:
in response to the component being another PVP/orchestrator, converting the policy into a policy profile; and
in response to the component being a cloud tool, converting the policy into a cloud policy.

12. The computer program product of claim 8, wherein the conversion from higher-levels of the policy assessor hierarchy to lower-levels of the policy assessor hierarchy converts controls of the policy to rules using a mapping of rules to controls.

13. The computer program product of claim 12, wherein the rules are converted to checks using a mapping of rules to checks.

14. The computer program product of claim 8, wherein the PVP/orchestrator acts as both a PVP and as an orchestrator.

15. A computer system, comprising:
one or more processors, one or more computer-readable memories and one or more computer-readable, tangible storage devices; and
program instructions, stored on at least one of the one or more computer-readable, tangible storage devices for execution by at least one of the one or more processors via at least one of the one or more computer-readable memories, to perform operations comprising:
under control of a Policy Validation Point (PVP)/orchestrator of a plurality of PVP/orchestrators in a policy assessor hierarchy, wherein the plurality of PVP/orchestrators are located at multiple, different levels, and wherein a first PVP/orchestrator of the plurality of PVP/orchestrators at a higher-level of the policy assessor hierarchy has more granular controls than a second PVP/orchestrator of the plurality of PVP/orchestrators at a lower-level of the policy assessor hierarchy,
receiving a policy;
determining a compliance granularity of the policy to be sent to a component of a particular lower-level of the policy assessor hierarchy;
converting the policy based on the determined compliance granularity into a format understood by the component at the particular lower-level, wherein the component returns a result indicating whether the policy was enforced by a service;
converting the result to a standard format; and
returning the converted result.

16. The computer system of claim 15, wherein a specific exchange protocol is provided for communication between components at adjacent levels of the policy assessor hierarchy.

17. The computer system of claim 15, wherein the program instructions further perform operations comprising:
under the control of the PVP/orchestrator,
receiving multiple results from one or more other PVPs/orchestrators at lower-levels of the policy assessor hierarchy;
aggregating the multiple results; and
returning the aggregated results.

18. The computer system of claim 15, wherein the program instructions further perform operations comprising:
in response to the component being another PVP/orchestrator, converting the policy into a policy profile; and
in response to the component being a cloud tool, converting the policy into a cloud policy.

19. The computer system of claim 15, wherein the conversion from higher-levels of the policy assessor hierarchy to lower-levels of the policy assessor hierarchy converts controls of the policy to rules using a mapping of rules to controls.

20. The computer system of claim 19, wherein the rules are converted to checks using a mapping of rules to checks.
